(19) United States
(12) Patent Application Publication
(10) Pub. No.: US 2026/0278857 A1
(43) Pub. Date: Sep. 17, 2026

(54) VISUAL CONTENT GENERATION

(71) Applicants: Bytedance Technology Ltd., Grand Cayman (KY); Beijing Zitiao Network Technology Co., Ltd., Beijing (CN)

(72) Inventors: Tiancheng SHEN, Beijing (CN); Jun Hao LIEW, Singapore (SG); Zilong HUANG, Singapore (SG); Xiangtai LI, Singapore (SG); Zhijie LIN, Singapore (SG); Jiyang LIU, Beijing (CN); Yitong WANG, Beijing (CN); Jiashi FENG, Singapore (SG)

(21) Appl. No.: 19/566,791

(22) Filed: Mar. 13, 2026

(30) Foreign Application Priority Data
Mar. 14, 2025 (CN) 202510312143.4

(51) Int. Cl. G06T 11/00

(52) U.S. Cl. CPC G06T 11/00

(57) ABSTRACT

The disclosure provides a method, an apparatus, a device, a storage medium and a program product for generating visual content. An example method includes: receiving a target text for target visual content, the target text describing a visual effect for the target visual content; determining a feature of at least one target dimension for an attention mechanism based on the target text and reference visual content for the target visual content, the at least one target dimension including at least one of a key dimension, a value dimension, or a query dimension; and generating the target visual content based on the feature of the at least one target dimension and an intermediate visual feature corresponding to the target visual content.

### CROSS-REFERENCE

This application claims the benefit of Chinese Patent Application No. 202510312143.4, filed on Mar. 14, 2025, entitled “METHOD, APPARATUS, DEVICE, STORAGE MEDIUM AND PROGRAM PRODUCT FOR GENERATING VISUAL CONTENT”, which is hereby incorporated by reference in its entirety.

### TECHNICAL FIELD

Example embodiments of the present disclosure generally relate to the field of computer technology, and in particular, to visual content generation.

### BACKGROUND

In the field of computer vision (CV), various visual content processing techniques based on machine learning have been significantly developed and widely used. For example, in many application scenarios such as social, gaming, image editing, and video editing, it is desired to generate and use visual content with a certain visual effect (e.g., a special effect, a filter). The visual content processing techniques based on machine learning may be used in such application scenarios to improve user experience. In some example application scenarios, it is desired to generate visual content (such as an image or a video) matching a user input based on information input by a user, such as text description information.

### SUMMARY

In a first aspect of the present disclosure, a method of generating visual content is provided. The method includes: receiving a target text for target visual content, the target text describing a visual effect for the target visual content; determining a feature of at least one target dimension for an attention mechanism based on the target text and reference visual content for the target visual content, the at least one target dimension including at least one of a key dimension, a value dimension, or a query dimension; and generating the target visual content based on the feature of the at least one target dimension and an intermediate visual feature corresponding to the target visual content.

In a second aspect of the present disclosure, an apparatus for generating visual content is provided. The apparatus includes: a receiving module configured to receive a target text for target visual content, the target text describing a visual effect for the target visual content; a determining module configured to determine a feature of at least one target dimension for an attention mechanism based on the target text and reference visual content for the target visual content, the at least one target dimension including at least one of a key dimension, a value dimension, or a query dimension; and a generating module configured to generate the target visual content based on the feature of the at least one target dimension and an intermediate visual feature corresponding to the target visual content.

In a third aspect of the present disclosure, an electronic device is provided. The device includes at least one processing unit; and at least one memory coupled to the at least one processing unit and storing instructions executable by the at least one processing unit, the instructions, when executed by the at least one processing unit, causing the device to perform the method of the first aspect.

In a fourth aspect of the present disclosure, a computer-readable storage medium is provided. The computer-readable storage medium has a computer program stored thereon which is executable by a processor to implement the method of the first aspect.

In a fifth aspect of the present disclosure, a computer program product is provided. The program product includes a computer program which is executable by a processor to implement the method of the first aspect.

It would be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments according to the present disclosure may be implemented;

FIG. 2 illustrates a schematic diagram of an example architecture for generating visual content according to some embodiments of the present disclosure;

FIG. 3 illustrates a schematic diagram of an example architecture of a machine learning model according to some embodiments of the present disclosure;

FIG. 4 illustrates a schematic diagram of a procedure of determining attention weight information according to some embodiments of the present disclosure;

FIG. 5 illustrates a flowchart of an example process of generating visual content according to some embodiments of the present disclosure;

FIG. 6 illustrates a schematic structural block diagram of an example apparatus for generating visual content according to some embodiments of the present disclosure; and

FIG. 7 illustrates a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although certain embodiments of the present disclosure are shown in the drawings, it would be appreciated that the present disclosure may be implemented in various forms and should not be construed as limited to the embodiments set forth herein. Rather, these embodiments are provided for a more thorough and complete understanding of the present disclosure. It would be appreciated that the drawings and embodiments of the present disclosure are only for illustrative purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

As used herein, unless explicitly stated, performing a step “in response to A” does not mean that the step is performed immediately after “A”, but may include one or more intermediate steps.

It would be appreciated that the data involved in the technical solution (including but not limited to the data itself, acquisition, use, storage or deletion of the data) should comply with requirements of corresponding laws, regulations and related provisions.

It would be appreciated that before using the technical solution disclosed in the embodiments of the present disclosure, the user shall be informed of the type, range of use, use scenarios, etc. of personal information involved in the present disclosure and the authorization of the user shall be obtained in an appropriate manner in accordance with relevant laws and regulations.

For example, in response to receiving an active request from a user, prompt information is sent to the user to clearly prompt the user that the requested operation will require access to and use of the user's personal information, so that the user may independently choose whether to provide the personal information to software or hardware, such as an electronic device, an application, a server or a storage medium, that performs the operations of the technical solution of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It would be appreciated that the above process of notifying and obtaining user authorization is only illustrative and does not limit the implementation of the present disclosure, and other methods that meet relevant laws and regulations may also be applied in the implementation of the present disclosure.

As used herein, the term “model” may learn the correlation between corresponding inputs and outputs from training data, so that after the training is completed, corresponding outputs may be generated for given inputs. The generation of the model may be based on machine learning techniques. Deep learning is a machine learning algorithm that uses multiple layers of processing units to process inputs and provide corresponding outputs. As used herein, a “model” may also be referred to as a “machine learning model”, a “machine learning network” or a “network”, which terms are used interchangeably herein. A model may in turn include different types of processing units or networks.

### Example Environment

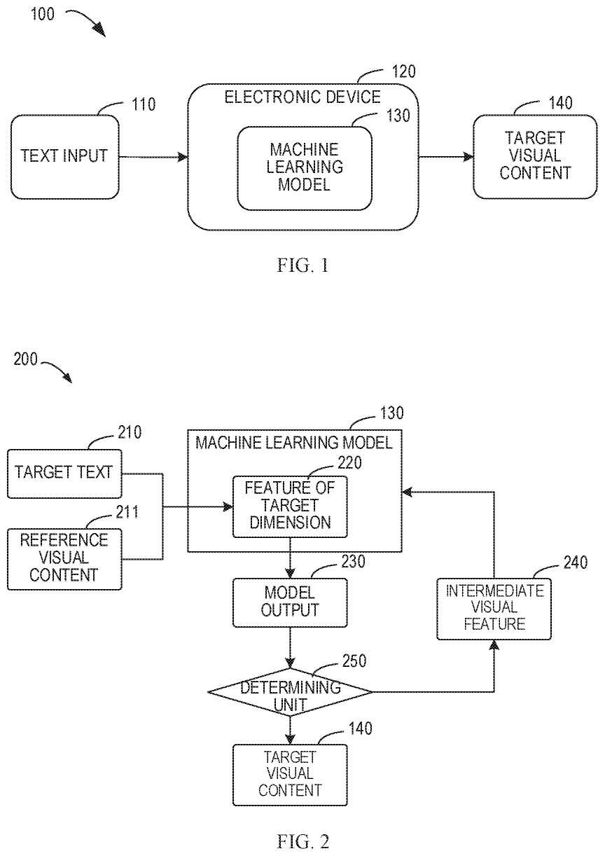

FIG. 1 illustrates a schematic diagram of an example environment 100 in which the embodiments of the present disclosure may be implemented. As shown in FIG. 1, the environment 100 may include an electronic device 120. In this example environment 100, the electronic device 120 may obtain a text input 110 related to visual content generation. The electronic device 120 may use a machine learning model 130 to generate target visual content (such as an image, a set of images, or a video) 140 corresponding to the text input based on the text input 110.

In some embodiments, the text input 110 may include a category of the target visual content 140 expected to generate, such as to generate a category of video or to generate a category of image. In some embodiments, the text input 110 may include attributes (such as color, contrast, or brightness) and image elements of the target visual content 140 expected to generate. As an example, the text input 110 may include “generate an image including a white cat”.

In some embodiments, the electronic device 120 may generate the target visual content 140 based on an image with random noise and the text input 110. The machine learning model 130 may gradually remove noise through a plurality of time steps to generate the target visual content 140.

In some embodiments, the electronic device 120 may use the trained machine learning model 130 to perform an image processing task. The machine learning model 130 may include, for example, but is not limited to, any appropriate model such as a Transformer model, a convolutional neural network (CNN), a recurrent neural network (RNN), a deep neural network (DNN), or a flow matching model. The machine learning model 130 may be a local model of the electronic device 120, or may be a model that the electronic device 120 may access in any suitable manner (for example, the machine learning model 130 is installed in a remote device).

In FIG. 1, the electronic device 120 may include any computing system with computing power, such as various computing devices/systems, terminal devices, servers, etc. The terminal device may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the above, including accessories and peripherals of these devices or any combination thereof. In some embodiments, the electronic device 120 may also support any type of user-specific interface (such as a “wearable” circuit, etc.).

It would be appreciated that the components and arrangements in the environment 100 shown in FIG. 1 are only examples, and the computing system suitable for implementing the example implementation described in the present disclosure may include one or more different components, other components, and/or different arrangements. The implementation of the present disclosure is not limited in this regard.

As briefly mentioned above, the machine learning model for performing the visual content processing task may generate visual content corresponding to user desires according to user requests. For example, the style of the visual content is changed or any object in the visual content is replaced.

Generally, a Transform-based generation model is used to implement the visual content generation task. Some generation models (such as diffusion models) fuse text indicating user requests and visual information (such as reference visual content or noise) into a joint embedding space, making the visual content generated by the model more contextually coherent and delicate. However, this type of generation model uses a joint self-attention mechanism and lacks the ability to explicitly and consistently use text to guide visual content generation, and there is semantic inconsistency between the editing result and the text. Therefore, in the process of generating visual content according to the request text, the model cannot take into account both the matching of the visual content and the text and the maintenance of the structure of the visual content, which affects the quality of the generated visual content.

Embodiments of the present disclosure provide a solution for generating visual content. In this solution, a text for target visual content is received. The received text (which may be also referred to as target text) describes a visual effect for the target visual content. A feature of at least one dimension (which may be also referred to as target dimension) for an attention mechanism is determined based on the target text and reference visual content for the target visual content, the at least one target dimension including at least one of a key dimension, a value dimension, or a query dimension. The target visual content is generated based on the feature of the at least one target dimension and an intermediate visual feature corresponding to the target visual content.

As can be seen, in the embodiments of the present disclosure, the feature for the attention mechanism is determined based on the reference visual content and the target text describing the visual effect, and the target visual content is generated based on the determined feature. In this way, the quality of the generated target visual content is improved. Furthermore, the features of different target dimensions for the attention mechanism are used to provide the user with target visual content that differs in the degree of adherence to the reference visual content, so as to meet user desires.

Some example embodiments of the present disclosure will be further described below with reference to the drawings.

### Example Process

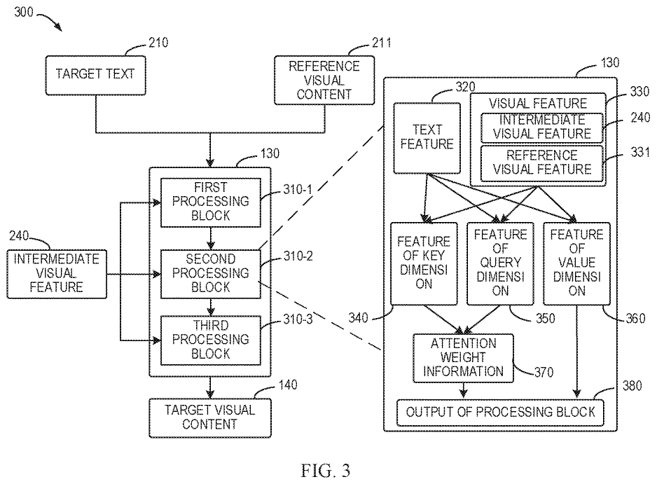

FIG. 2 illustrates a schematic diagram of an example architecture 200 for generating visual content according to some embodiments of the present disclosure. As shown in FIG. 2, the architecture 200 may be implemented or included in the electronic device 120.

In some embodiments, the electronic device 120 may perform a processing task including a plurality of rounds (that is, a plurality of processing steps) by using a machine learning model. For example, if the machine learning model 130 is a diffusion model, the plurality of processing steps may be a plurality of denoising steps. The electronic device 120 calls the machine learning model 130 in the plurality of denoising steps to remove noise in the image. As an example, in the case where the machine learning model is used to perform the processing step of the first round, the initial input (that is, the target text 210 and the initial noise image) is provided to the machine learning model 130 to obtain the result of the processing step. In the next round, the result of the previous processing step is provided to the machine learning model to obtain the result of the current processing step. The above steps are repeated, and the result of the processing step of the final round is used as the target output of the processing task. In some embodiments, the model input includes visual content with random noise (for example, an image with random noise) input in the first round or denoised visual content (for example, a denoised image) generated in the previous processing step. In some embodiments, the model input may include the reference visual content 211 input in the first round, and the machine learning model 130 performs visual content generation based on the target text 210 and the reference visual content 211. The architecture 200 will be mainly described below by using an example of a certain processing step of the plurality of processing steps.

In some embodiments, the electronic device 120 receives a target text 210 for the target visual content 140. In some embodiments, the target text 210 may be determined based on information entered by a user. As an example, the information entered by the user may be “generate a white dog”. In some embodiments, the target text 210 may be determined based on a previous processing flow. As an example, the previous processing flow may be an evaluation flow for the visual content, and the target text 210 may be determined based on the evaluation result of the evaluation flow. The target text 210 describes a visual effect for the target visual content 140. As an example, the target text 210 may include an image attribute (for example, contrast, brightness) of the target visual content 140 or an image element included in the target visual content 140.

In some embodiments, the electronic device 120 provides the target text 210 and the reference visual content 211 to the machine learning model 130. The machine learning model 130 determines a feature 220 of at least one target dimension for an attention mechanism based on the target text 210 and the reference visual content 211 for the target visual content. In the process of determining the feature of the target dimension, the target visual content 140 is replaced with the reference visual content 211. That is, the feature corresponding to the target visual content 140 is replaced with the feature corresponding to the reference visual content 211 in the target dimension. As an example, if the target dimension is the query dimension and the key dimension, the above replacement operation is a replacement performed for the query component and the key component.

The reference visual content 211 may be visual content provided or specified by the user. As an example, the reference visual content 211 may be used as supplementary content for the target text 210. For example, if the reference visual content 211 is an image including a “dog by the sea”, the target text 210 may be “generate a cat by the sea based on image A”. In some embodiments, the reference visual content 211 may be determined based on the target text 210. As an example, the target text 210 may be “a video of a night view of street A with fireworks blooming in the sky”, and the electronic device 120 may use, according to retrieval, a video about street A (for example, a video of street A in the daytime) as the reference visual content 211.

In some embodiments, the target text 210 and the reference visual content 211 may be used to generate the feature 220 of the target dimension in a plurality of processing steps, and the feature 220 of the target dimension may be used to generate the target visual content 140. In some embodiments, the above operations may be performed in some of the processing steps. As an example, the feature 220 of the at least one target dimension may be determined based on the target text and the reference visual content in a first group of processing steps of the plurality of processing steps. In a second group of processing steps of the plurality of processing steps, features of the key dimension, the value dimension, and the query dimension for the attention mechanism are determined based on the target text and the intermediate visual feature. In this way, the first group of processing steps is determined according to different application scenarios or user needs, so that the above replacement operation is performed only in some of the processing steps, and the generated target visual content 140 better meets user desires.

In order to further improve the quality of the generated visual content, the feature of the at least one target dimension may be determined based on the target text and the reference visual content in an earlier processing step of the plurality of processing steps. In some embodiments, the first group of processing steps and the second group of processing steps may include one or more processing steps. In some embodiments, the first group of processing steps may be a plurality of consecutive processing steps, and the first group of processing steps may be before the second group of processing steps, so that the above operations are performed in the early stage of performing the generation task, and the quality of the generated visual content is further improved. In some embodiments, the first group of processing steps may be non-consecutive processing steps, and the second group of processing steps may also be non-consecutive processing steps.

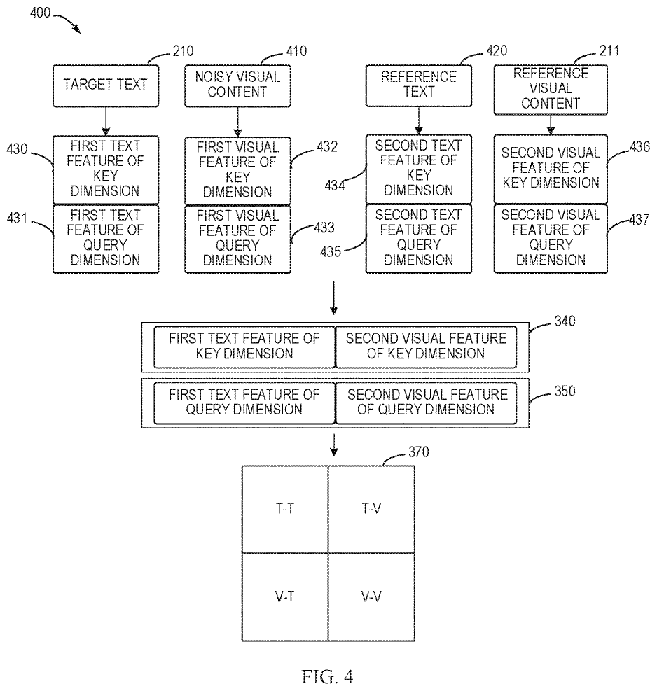

FIG. 3 illustrates a schematic diagram of an example architecture 300 of a machine learning model according to some embodiments of the present disclosure. As shown in FIG. 3, the architecture 300 may be implemented or included in the electronic device 120, and the architecture 300 may be a diffusion model or a flow matching model. The diffusion model may use randomly sampled noise z~N(0, I) as input and generate the target visual content 140 corresponding to the target text 210 and the reference visual content 211 through T iterations. The flow matching model may use the randomly sampled noise z~N(0, I) as input and gradually evolve in a time interval t∈[0, 1] by learning a time-dependent vector field to generate the target visual content 140 corresponding to the target text 210 and the reference visual content 211. By matching the model vector field with the target vector field, the flow matching model may efficiently recover visual content with a high-quality from noise while maintaining the consistency of the target visual content 140 with the target text 210 and the reference visual content 211.

In some embodiments, the machine learning model 130 includes a plurality of processing blocks based on an attention mechanism. As shown in FIG. 3, the machine learning model 130 may include a first processing block 310-1, a second processing block 310-2, and a third processing block 310-3, which may be individually referred to as a processing block 310 or collectively referred to as processing blocks 310. The number of processing blocks 310 shown in FIG. 3 is only an example and not intended to be any limitation. The processing block 310 generates a feature 340 of a key (K) dimension, a feature 350 of a query (Q) dimension, and a feature 360 of a value (V) dimension based on the obtained text feature 320 and visual feature 330. In some embodiments, the text feature 320 may be determined based on the target text 210. The visual feature 330 includes the intermediate visual feature 240 and a reference visual feature 331 corresponding to the reference visual content 211. As an example, an embedding representation of the target text 210 and an embedding representation of the reference visual content 211 are first determined. Then, a corresponding text feature 320 and visual feature 330 are generated based on the determined target dimension and the corresponding embedding representation.

In some embodiments, in a certain processing step of the plurality of processing steps, the operation of determining the feature 220 of the target dimension based on the target text 210 and the reference visual content 211 may be performed in all the processing blocks 310. In some embodiments, all the processing blocks of the machine learning model 130 may be divided into a first partial processing block and a second partial processing block. Then, in the first partial processing block, the above operation is performed, that is, the feature 220 of the target dimension is determined based on the text feature 320 and the reference visual feature 331. In the second partial processing block, the operation of determining the feature 220 of the target dimension based on the target text 210 and the intermediate visual feature 240 generated in a previous processing step is performed, that is, the feature 220 of the target dimension is generated based on the text feature 320 and the intermediate visual feature 240. In some embodiments, if the certain processing step is the first processing step, the feature 220 of the target dimension is determined based on the feature of the noise image that is initially inputted. In this way, the first partial processing block that needs to perform the above operations is determined according to different application scenarios or user needs, and the above operations are performed only in the first partial processing block, so that the target visual content generated by the model better meets user desires.

In some embodiments, in order to further improve the quality of the generated visual content, the feature of the at least one target dimension may be determined based on the target text and the reference visual content in an earlier processing block of the plurality of processing blocks.

In some embodiments, the target dimension may be the query dimension, the key dimension, or the value dimension for the attention mechanism. The feature determined based on the target text 210 and the reference visual content 211 may be a feature of a single dimension or features of a plurality of dimensions. As an example, only the feature 350 of the query dimension may be generated or the feature 350 of the query dimension and the feature 340 of the key dimension may be generated, which is not limited here. In some embodiments, the target dimension may be determined based on a predetermined parameter or user needs. As an example, a user input indicating a generation requirement may be received, and at least one target dimension may be selected from the key dimension, the value dimension, and the query dimension based on the user input, so that the determined target dimension may meet the user needs. The generation requirement indicates a degree of adherence of the target visual content 140 to the reference visual content 211. For example, if the user expects the target visual content 140 to be more in line with the reference visual content 211, the value dimension is used as the target dimension. If the user expects the target visual content 140 to be in line with both the reference visual content 211 and the target text 210, the query dimension and the key dimension are used as the target dimensions. The features of the dimensions other than the target dimension may be determined based on the text feature 320 and the intermediate visual feature 240.

In order to improve the quality of the generated target visual content, the query dimension and the key dimension may be used as the target dimensions. In this case, the feature 340 of the key dimension and the feature 350 of the query dimension may be generated based on the text feature 320 and the reference visual feature 331, and the feature 360 of the value dimension is determined based on the text feature 320 and the intermediate visual feature 240. As an example, a first query feature and a first key feature may be first generated based on the text feature 320 and the intermediate visual feature 240, and a second query feature and a second key feature may be generated based on the reference visual content 211 and a reference text corresponding to the reference visual content 211. Then, the key feature corresponding to the intermediate visual feature 240 in the first query feature is replaced with the key feature corresponding to the reference visual content 211 in the second query feature, and the query feature corresponding to the intermediate visual feature 240 in the first query feature is replaced with the query feature corresponding to the reference visual content 211 in the second query feature, so as to generate the feature of the at least one target dimension.

FIG. 4 illustrates a schematic diagram of a process 400 of determining attention weight information according to some embodiments of the present disclosure. As shown in FIG. 4, in the case that the target dimensions are the query dimension and the key dimension, a first text feature 430 of the key dimension and a first text feature 431 of the query dimension are generated based on the target text 210. A first visual feature 432 of the key dimension and a first visual feature 433 of the query dimension are generated based on noisy visual content 410 (including the initial noise image and the intermediate visual content generated in each processing step). The noisy visual content 410 includes the initial noise image and the intermediate visual content generated in each processing step. A second text feature 434 of the key dimension and a second text feature 435 of the query dimension are generated based on a reference text 420. The reference text 420 includes a description for a visual effect of the reference visual content 211. A second visual feature 436 of the key dimension and a second visual feature 437 of the query dimension are generated based on the reference visual content 211.

As shown in FIG. 4, the feature 340 of the key dimension is generated by combining the first text feature 430 of the key dimension and the second visual feature 436 of the key dimension, and the feature 350 of the query dimension is generated by combining the first text feature 431 of the query dimension and the second visual feature 437 of the query dimension. The above combination operation is equivalent to replacing the feature of the key dimension and the feature of the query dimension corresponding to the intermediate visual feature in the first query feature with the feature of the key dimension and the feature of the query dimension corresponding to the reference visual content 211 in the second query feature. In some embodiments, combining the text feature of the target dimension and the visual feature of the target dimension includes concatenating the text feature of the target dimension with the visual feature of the target dimension.

Then, the attention weight information 370 is obtained based on the feature 340 of the key dimension and the feature 350 of the query dimension. The attention weight information 370 includes four quadrants T-T, T-V, V-T, and V-V, which represent text-to-text, text-to-visual, visual-to-text, and visual-to-visual, respectively. In the case that the target dimensions include the key dimension and the query dimension, it is equivalent to that the replacement of the target visual content with the reference visual content occurs in the V-T and V-V quadrants. Continuing to refer to FIG. 3, an output 380 of the processing block is generated by applying the attention weight information 370 to the feature 360 of the value dimension. The output 380 of the processing block is provided to a subsequent processing block for generating the model output 230 corresponding to the processing step. In this way, a balance between the goal of matching the visual content with the text and the goal of maintaining the structure of the visual content may be achieved, thereby improving the quality of the generated visual content.

Continuing to refer to FIG. 2. The electronic device 120 may generate the target visual content 140 based on the determined feature of the target dimension and the intermediate visual feature 240 corresponding to the target visual content 140. The intermediate visual feature 240 may include a plurality of intermediate visual features corresponding to the plurality of processing steps, respectively. As shown in FIG. 2, in each processing step, after obtaining the model output 230 of the machine learning model, the determining unit 250 may be used to determine whether the current processing step is the final processing step. The determining unit 250 determines whether the current processing step is the final processing step by determining that the model output 230 does not satisfy a predetermined condition or the current number of iterations is less than the predetermined number of iterations. As an example, if the machine learning model 130 is a diffusion model, it is determined whether the time step corresponding to the current processing step is t=0.

If it is not the final processing step, the intermediate visual feature 240 is determined based on the model output of the current step, and the intermediate visual feature 240 is provided to the machine learning model 130 to perform the next processing step using the machine learning model 130. If it is the final processing step, the target visual content 140 is generated based on the model output 230. As an example, the intermediate visual content generated in the previous processing step may be denoised based on the model output 230 to generate the target visual content 140.

It may be seen that in the embodiments of the present disclosure, on the one hand, the target visual content is replaced with the reference visual content, so that the feature for the attention mechanism is generated based on the target text and the reference visual content, so as to implement precise text-guided editing. In this way, the quality of the generated target visual content is improved, thereby maintaining, in the process of generating the target visual content, the spatial-temporal consistency and structural consistency between the target visual content and the reference visual content. On the other hand, by replacing the query component, the key component, and the value component in the machine learning model, the efficiency of generating the visual content is improved without an additional training process.

### Example Process

FIG. 5 illustrates a flowchart of an example process 500 of generating visual content according to some embodiments of the present disclosure. The process 500 may be implemented at the electronic device 120. The process 500 will be described below with reference to FIG. 1.

As shown in FIG. 5, at block 510, the electronic device 120 receives a target text for target visual content, the target text describing a visual effect for the target visual content.

At block 520, the electronic device 120 determines a feature of at least one target dimension for an attention mechanism based on the target text and reference visual content for the target visual content, the at least one target dimension including at least one of a key dimension, a value dimension, or a query dimension.

At block 530, the electronic device 120 generates the target visual content based on the feature of the at least one target dimension and an intermediate visual feature corresponding to the target visual content.

In some embodiments, the at least one target dimension includes the key dimension and the query dimension, and determining the feature of the at least one target dimension includes: determining a text feature of the key dimension and a text feature of the query dimension based on the target text; determining a visual feature of the key dimension and a visual feature of the query dimension based on the reference visual content; generating the feature of the key dimension by combining the visual feature of the key dimension and the text feature of the key dimension; and generating the feature of the query dimension by combining the text feature of the query dimension and the visual feature of the query dimension.

In some embodiments, generating the target visual content includes: determining a feature of the value dimension based on a text feature of the target text and the intermediate visual feature; obtaining attention weight information based on the feature of the key dimension and the feature of the query dimension; and generating the target visual content by applying the attention weight information to the feature of the value dimension.

In some embodiments, determining the feature of the at least one target dimension includes, for a target dimension in the at least one target dimension: determining a text feature of the target dimension based on the target text; determining a visual feature of the target dimension based on the reference visual content; and generating the feature of the target dimension by combining the text feature of the target dimension and the visual feature of the target dimension.

In some embodiments, combining the text feature of the target dimension and the visual feature of the target dimension includes concatenating the text feature of the target dimension with the visual feature of the target dimension.

In some embodiments, generating the target visual content from the target text includes a plurality of processing steps using a machine learning model, and determining the feature of the at least one target dimension based on the target text and the reference visual content is performed in a first group of processing steps of the plurality of processing steps; and in a second group of processing steps of the plurality of processing steps, features of the key dimension, the value dimension, and the query dimension for the attention mechanism are determined based on the target text and the intermediate visual feature.

In some embodiments, the first group of processing steps are before the second group of processing steps.

In some embodiments, the machine learning model includes a plurality of processing blocks based on the attention mechanism, and determining the feature of the at least one target dimension based on the target text and the reference visual content is performed for a portion of the plurality of processing blocks.

In some embodiments, the process 500 further includes: receiving a user input indicating a generation requirement, the generation requirement indicating a degree of adherence of the target visual content to the reference visual content; and selecting the at least one target dimension from the key dimension, the value dimension, and the query dimension based on the generation requirement.

### Example Apparatus and Device

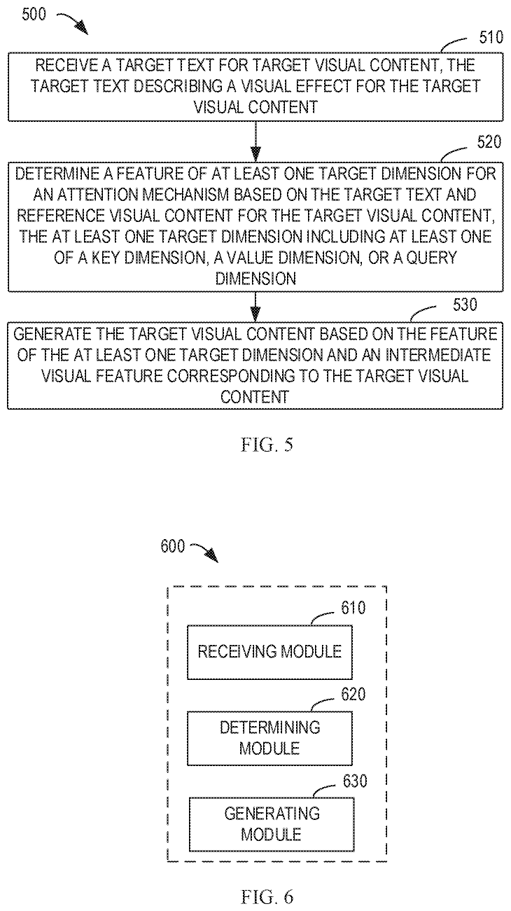

The embodiments of the present disclosure further provide a corresponding apparatus for implementing the above methods or processes. FIG. 6 illustrates a schematic structural block diagram of an example apparatus 600 for generating visual content according to some embodiments of the present disclosure. The apparatus 600 may be implemented as or included in the electronic device 120. Each module/component in the apparatus 600 may be implemented by hardware, software, firmware, or any combination thereof.

As shown in FIG. 6, the apparatus 600 includes: a receiving module 610 configured to receive a target text for target visual content, the target text describing a visual effect for the target visual content; a determining module 620 configured to determine a feature of at least one target dimension for an attention mechanism based on the target text and reference visual content for the target visual content, the at least one target dimension including at least one of a key dimension, a value dimension, or a query dimension; and a generating module 630 configured to generate the target visual content based on the feature of the at least one target dimension and an intermediate visual feature corresponding to the target visual content.

In some embodiments, the determining module 620 is further configured to determine a text feature of the key dimension and a text feature of the query dimension based on the target text; determine a visual feature of the key dimension and a visual feature of the query dimension based on the reference visual content; generate the feature of the key dimension by combining the visual feature of the key dimension and the text feature of the key dimension; and generate the feature of the query dimension by combining the text feature of the query dimension and the visual feature of the query dimension.

In some embodiments, the determining module 620 is further configured to determine a feature of the value dimension based on a text feature of the target text and the intermediate visual feature; obtain attention weight information based on the feature of the key dimension and the feature of the query dimension; and generate the target visual content by applying the attention weight information to the feature of the value dimension.

In some embodiments, the determining module 620 is further configured to determine a text feature of the target dimension based on the target text; determine a visual feature of the target dimension based on the reference visual content; and generate the feature of the target dimension by combining the text feature of the target dimension and the visual feature of the target dimension.

In some embodiments, combining the text feature of the target dimension and the visual feature of the target dimension includes concatenating the text feature of the target dimension with the visual feature of the target dimension.

In some embodiments, generating the target visual content from the target text includes a plurality of processing steps using a machine learning model, and determining the feature of the at least one target dimension based on the target text and the reference visual content is performed in a first group of processing steps of the plurality of processing steps; and in a second group of processing steps of the plurality of processing steps, features of the key dimension, the value dimension, and the query dimension for the attention mechanism are determined based on the target text and the intermediate visual feature.

In some embodiments, the first group of processing steps are before the second group of processing steps.

In some embodiments, the machine learning model includes a plurality of processing blocks based on the attention mechanism, and determining the feature of the at least one target dimension based on the target text and the reference visual content is performed for a portion of the plurality of processing blocks.

In some embodiments, the apparatus 600 further includes a selecting module configured to receive a user input indicating a generation requirement, the generation requirement indicating a degree of adherence of the target visual content to the reference visual content; and select the at least one target dimension from the key dimension, the value dimension, and the query dimension based on the generation requirement.

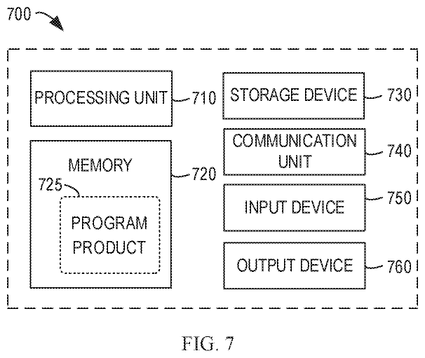

FIG. 7 illustrates a block diagram of an electronic device 700 capable of implementing a plurality of embodiments of the present disclosure. As shown in FIG. 7, the electronic device 700 is in the form of a general-purpose electronic device. The components of the electronic device 700 may include, but are not limited to, one or more processors or processing units 710, a memory 720, a storage device 730, one or more communication units 740, one or more input devices 770, and one or more output devices 760. The processing unit 710 may be an actual or virtual processor and may perform various processes based on the programs stored in the memory 720. In a multi-processor system, a plurality of processing units executes computer executable instructions in parallel to improve the parallel processing capability of the electronic device 700.

The electronic device 700 typically includes a plurality of computer storage media. Such media may be any available medium that is accessible by the electronic device 700, including, but not limited to, volatile and non-volatile medium, removable and non-removable medium. The memory 720 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 730 may be any removable or non-removable medium, and may include a machine-readable medium such as a flash drive, a disk, or any other medium, which may be used to store information and/or data and may be accessed within the electronic device 700.

The electronic device 700 may further include additional removable/non-removable, volatile/non-volatile memory medium. Although not shown in FIG. 7, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 720 may include a computer program product 725, which has one or more program modules configured to perform various methods or acts of the various embodiments of the present disclosure.

The communication unit 740 enables communication with other electronic devices through the communication medium. Additionally, the functions of the components of the electronic device 700 may be implemented by a single computing cluster or a plurality of computing machines, which may communicate through communication connections. Therefore, the electronic device 700 may use a logical connection with one or more other servers, a network personal computer (PC) or another network node to operate in a networked environment.

The input device 770 may be one or more input devices, such as a mouse, a keyboard, a tracking ball, etc. The output device 760 may be one or more output devices, such as a display, a speaker, a printer, etc. The electronic device 700 may further communicate with one or more external devices (not shown) through the communication unit 740 as needed, the external devices such as a storage device, a display device, etc., communicate with one or more devices that enable the user to interact with the electronic device 700, or communicate with any device (for example, a network card, a modem, etc.) that enables the electronic device 700 to communicate with one or more other electronic devices. Such communication may be performed via input/output (I/O) interfaces (not shown).

According to an example implementation of the present disclosure, there is provided a computer-readable storage medium having computer executable instructions stored thereon, the computer executable instructions being executed by a processor to implement the method described above. According to an example implementation of the present disclosure, there is further provided a computer program product tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, create means for implementing the functions/acts specified in one or more blocks of the flowcharts and/or block diagrams. These computer-readable program instructions may also be stored in a computer-readable storage medium, these instructions cause the computer, the programmable data processing apparatus, and/or other devices to work in a particular manner, such that the computer-readable medium storing the instructions includes an article of manufacture including instructions for implementing various aspects of the functions/acts specified in one or more blocks of the flowcharts and/or block diagrams.

The computer-readable program instructions may be loaded onto a computer, another programmable data processing apparatus, or other devices, such that a series of operating steps are performed on the computer, the other programmable data processing apparatus, or the other devices to generate a computer-implemented process, such that the instructions executed on the computer, the other programmable data processing apparatus, or the other devices implement the functions/acts specified in one or more blocks of the flowcharts and/or block diagrams.

The flowcharts and block diagrams in the drawings illustrate the possibly implemented architectures, functions and operations of the system, method and computer program product according to a plurality of implementations of the present disclosure. In this regard, each block in the flowchart or block diagram may represent a module, program segment, or portion of instructions, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It would also be noted that each block of the block diagrams and/or flowcharts, and combinations of blocks in the block diagrams and/or flowcharts, may be implemented by special-purpose hardware-based systems that perform specified functions or acts, or may be implemented by combinations of special-purpose hardware and computer instructions.

The implementations of the present disclosure have been described above, and the above description is example, non-exhaustive, and not limited to the disclosed implementations. Many modifications and variations will be apparent to those of ordinary skill in the art without departing from the scope and spirit of the illustrated implementations. The selection of terms used herein is intended to best explain the principles, practical applications, or improvements to the technology in the market of the implementations, or to enable other ordinary skilled persons in the art to understand the implementations disclosed herein.

I/We claim:

1. A method of generating visual content, comprising:
receiving a text for target visual content, the received text describing a visual effect for the target visual content;
determining a feature of at least one dimension for an attention mechanism based on the received text and reference visual content for the target visual content, the at least one dimension comprising at least one of a key dimension, a value dimension, or a query dimension; and
generating the target visual content based on the feature of the at least one dimension and an intermediate visual feature corresponding to the target visual content.

2. The method of claim 1, wherein the at least one dimension comprises the key dimension and the query dimension, and determining the feature of the at least one dimension comprises:
determining a text feature of the key dimension and a text feature of the query dimension based on the received text;
determining a visual feature of the key dimension and a visual feature of the query dimension based on the reference visual content;
generating the feature of the key dimension by combining the visual feature of the key dimension and the text feature of the key dimension; and
generating the feature of the query dimension by combining the text feature of the query dimension and the visual feature of the query dimension.

3. The method of claim 2, wherein generating the target visual content comprises:
determining a feature of the value dimension based on a text feature of the received text and the intermediate visual feature;
obtaining attention weight information based on the feature of the key dimension and the feature of the query dimension; and
generating the target visual content by applying the attention weight information to the feature of the value dimension.

4. The method of claim 1, wherein determining the feature of the at least one dimension comprises, for a dimension in the at least one dimension:
determining a text feature of the dimension based on the received text;
determining a visual feature of the dimension based on the reference visual content; and
generating the feature of the dimension by combining the text feature of the dimension and the visual feature of the dimension.

5. The method of claim 4, wherein combining the text feature of the dimension and the visual feature of the dimension comprises concatenating the text feature of the dimension with the visual feature of the dimension.

6. The method of claim 1, wherein generating the target visual content from the received text comprises a plurality of processing steps using a machine learning model, and determining the feature of the at least one dimension based on the received text and the reference visual content is performed in a first group of processing steps of the plurality of processing steps, and in a second group of processing steps of the plurality of processing steps, features of the key dimension, the value dimension, and the query dimension for the attention mechanism are determined based on the received text and the intermediate visual feature.

7. The method of claim 6, wherein the first group of processing steps are before the second group of processing steps.

8. The method of claim 6, wherein the machine learning model comprises a plurality of processing blocks based on the attention mechanism, and determining the feature of the at least one dimension based on the received text and the reference visual content is performed for a portion of the plurality of processing blocks.

9. The method of claim 1, further comprising:
receiving a user input indicating a generation requirement, the generation requirement indicating a degree of adherence of the target visual content to the reference visual content; and
selecting the at least one dimension from the key dimension, the value dimension, and the query dimension based on the generation requirement.

10. An electronic device, comprising:
at least one processor; and
at least one memory coupled to the at least one processor and storing instructions executable by the at least one processor, the instructions, when executed by the at least one processor, causing the electronic device to perform acts comprising:
receiving a text for target visual content, the received text describing a visual effect for the target visual content;
determining a feature of at least one dimension for an attention mechanism based on the received text and reference visual content for the target visual content, the at least one dimension comprising at least one of a key dimension, a value dimension, or a query dimension; and
generating the target visual content based on the feature of the at least one dimension and an intermediate visual feature corresponding to the target visual content.

11. The device of claim 10, wherein the at least one dimension comprises the key dimension and the query dimension, and determining the feature of the at least one dimension comprises:
determining a text feature of the key dimension and a text feature of the query dimension based on the received text;
determining a visual feature of the key dimension and a visual feature of the query dimension based on the reference visual content;
generating the feature of the key dimension by combining the visual feature of the key dimension and the text feature of the key dimension; and
generating the feature of the query dimension by combining the text feature of the query dimension and the visual feature of the query dimension.

12. The device of claim 11, wherein generating the target visual content comprises:
determining a feature of the value dimension based on a text feature of the received text and the intermediate visual feature;
obtaining attention weight information based on the feature of the key dimension and the feature of the query dimension; and
generating the target visual content by applying the attention weight information to the feature of the value dimension.

13. The device of claim 10, wherein determining the feature of the at least one dimension comprises, for a dimension in the at least one dimension:
determining a text feature of the dimension based on the received text;
determining a visual feature of the dimension based on the reference visual content; and
generating the feature of the dimension by combining the text feature of the dimension and the visual feature of the dimension.

14. The device of claim 13, wherein combining the text feature of the dimension and the visual feature of the dimension comprises concatenating the text feature of the dimension with the visual feature of the dimension.

15. The device of claim 10, wherein generating the target visual content from the received text comprises a plurality of processing steps using a machine learning model, and determining the feature of the at least one dimension based on the received text and the reference visual content is performed in a first group of processing steps of the plurality of processing steps, and in a second group of processing steps of the plurality of processing steps, features of the key dimension, the value dimension, and the query dimension for the attention mechanism are determined based on the received text and the intermediate visual feature.

16. The device of claim 15, wherein the first group of processing steps are before the second group of processing steps.

17. The device of claim 15, wherein the machine learning model comprises a plurality of processing blocks based on the attention mechanism, and determining the feature of the at least one dimension based on the received text and the reference visual content is performed for a portion of the plurality of processing blocks.

18. The device of claim 10, wherein the acts further comprise:
receiving a user input indicating a generation requirement, the generation requirement indicating a degree of adherence of the target visual content to the reference visual content; and
selecting the at least one dimension from the key dimension, the value dimension, and the query dimension based on the generation requirement.

19. A non-transitory computer-readable storage medium having a computer program stored thereon which is executable by a processor to perform acts comprising:
receiving a text for target visual content, the received text describing a visual effect for the target visual content;
determining a feature of at least one dimension for an attention mechanism based on the received text and reference visual content for the target visual content, the at least one dimension comprising at least one of a key dimension, a value dimension, or a query dimension; and
generating the target visual content based on the feature of the at least one dimension and an intermediate visual feature corresponding to the target visual content.

20. The medium of claim 19, wherein the at least one dimension comprises the key dimension and the query dimension, and determining the feature of the at least one dimension comprises:
determining a text feature of the key dimension and a text feature of the query dimension based on the received text;
determining a visual feature of the key dimension and a visual feature of the query dimension based on the reference visual content;
generating the feature of the key dimension by combining the visual feature of the key dimension and the text feature of the key dimension; and
generating the feature of the query dimension by combining the text feature of the query dimension and the visual feature of the query dimension.
